(19) United States
(12) Patent Application Publication
(10) Pub. No.: US 2019/0283801 A1
(43) Pub. Date: Sep. 19, 2019

(54) STEERING DEVICE FOR A VEHICLE

(71) Applicant: ZF Friedrichshafen AG, Friedrichshafen (DE)

(72) Inventors: Uwe FEHR, Friedrichshafen (DE); Jens HEIMANN, Stetten (DE); Alexander NEU, Friedrichshafen (DE); Georges HALSDORF, Lindau (DE)

(21) Appl. No.: 16/332,890

(22) PCT Filed: Aug. 8, 2017
(86) PCT No.: PCT/EP2017/069982

§ 371 Date: Mar. 13, 2019

(30) Foreign Application Priority Data
Sep. 16, 2016 (DE) 10 2016 217 773.7

(51) Int. Cl. B62D 7/09; B62D 7/20

(52) U.S. Cl. CPC B62D 7/09; B62D 7/20

(57) ABSTRACT

A steering device for a vehicle, having an actuator, which is provided to exert an axial force on a push rod. The push rod is pivotally connected to respective coupling rods on both sides. The respective coupling rods are pivotally connected to respective deflection levers. The respective deflection levers are pivotally connected to respective tie rods. The respective tie rods are pivotally connected to respective steering levers which are being operatively connected to respective hub carriers to steer respective wheels of a vehicle axle in accordance with axial movement of the push rod. The deflection levers alter a transmission ratio between the push rod and the respective tie rods to lower the axial force at the actuator.

This application is a National Stage completion of PCT/EP2017/069982 filed Aug. 8, 2017, which claims priority from German patent application serial no. 10 2016 217 773.7 filed Sep. 16, 2016.

### FIELD OF THE INVENTION

The invention relates to a steering device for a vehicle, in particular for a car or a commercial vehicle. The area of applicability of the invention extends to both independent suspensions and to rigid axles of vehicles.

### BACKGROUND OF THE INVENTION

When independent wheel suspensions are used in passenger cars and commercial vehicles, such as tractor units, rack-and-pinion steering systems are used. The rack-and-pinion steering system comprises a linear actuator, which is connected to the suspension using tie rods.

Because of the way the system operates, the rack-and-pinion steering system has a strongly varying transmission ratio between the actuator and the wheel movement. Due to the extension in the end positions, a comparatively large actuator force is required there. Therefore, the actuator performance is designed such that the actuator force is sufficient for the initiation of a maximum steering angle, although the torque occurring at the steering axis of the wheel acts in an almost constant manner along the steering angle.

In DE 10 2006 052 252 A1 an independent suspension for a motor vehicle is shown, in which at least one first and at least one second arm are each coupled to a hub carrier supporting a vehicle wheel in an articulated manner. The independent suspension has compensation means for correcting wheel positions, wherein at least the first and the second arm have a compensation means or are connected to a compensation means and at least two compensation means of each wheel are connected to each other by at least one coupling member.

### SUMMARY OF THE INVENTION

The invention addresses the problem of developing a steering device for a vehicle, wherein in particular the steering kinematics of the steering device is to be improved.

The object is solved by the subject matter of the independent claims. Preferred embodiments are the subject of the dependent claims.

The steering device for a vehicle according to the invention comprises an actuator, which is provided to exert an axial force on a push rod, wherein the push rod is pivotally connected to respective coupling rods on both sides, wherein the respective coupling rods are pivotally connected to respective deflection levers, wherein the respective deflection levers are pivotally connected to respective tie rods, and wherein the respective tie rods are pivotally connected to respective steering levers, wherein the respective steering levers are operatively connected to respective hub carriers to steer the respective wheels of a vehicle axle in accordance with an axial movement of the push rod, and wherein the respective deflection levers are intended to alter a gear ratio between the push rod and the respective tie rods to lower the axial force at the actuator.

In other words, a ratio change is performed at the respective deflection levers, wherein the maximum axial force that has to be applied by the actuator to set a maximum steering angle is significantly reduced. Thus, the actuator can be designed for lower power, wherein the power reduction of actuator is accompanied by a reduction in weight and cost. The actuator is designed to be particularly compact.

Furthermore, the solution according to the invention offers greater freedom of design based on the selection of the individual translation. In particular, a steering angle error can be reduced in that way.

An articulated connection denotes two pivotally interconnected components, such as the coupling rod and the deflection lever, being movably interconnected and having at least one degree of freedom. In particular, the respective coupling rods and the respective deflection levers are connected to each other by means of a ball joint. Preferably, the respective deflection levers are connected to the respective tie rods by means of a ball joint or by means of a rubber bearing.

In this context, operatively connected means that two elements can be directly connected to each other, or that there are further elements between two elements, for instance one or more shafts, coupling rods or similar elements.

Preferably, the respective deflection levers have a first and a second leg, wherein the two legs are rotationally engaged with each other. Thus, the two legs of the respective deflection levers enclose an angle, which is fixed and thus unalterable. In particular, the respective deflection levers are formed in one piece.

Preferably, the respective deflection levers are at least partially fixed, wherein the respective deflection levers have hinge joints for performing a swivel movement. The hinge joints have a single degree of freedom and thus permit rotation about the fixed point in a limited angular range. Owing to the hinge joint, the actuator does not affect the track change when the suspension of the respective wheels is compressed. This is because the hinge joints permit solely a rotational movement around the specified point.

In particular, the deflection lever is formed fixed to the frame or the arm or the hub carrier. Thus, the respective deflection levers, or at least a section of the respective deflection levers according to a first exemplary embodiment can be firmly attached to a relevant frame component of the vehicle. According to a second exemplary embodiment, the respective deflection levers, or at least a section of the respective deflection levers can be firmly attached to the respective arm of the vehicle.

According to a third exemplary embodiment, the respective deflection levers, or at least a section of the respective deflection levers can be firmly attached to the respective hub carriers of the vehicle. A swivel movement of the respective deflection levers is always possible.

The invention includes the technical teaching of the actuator being operatively connected to an input shaft, wherein the actuator is provided to convert rotational movement of the input shaft into a translatory movement of the push rod. A translatory movement denotes a linear movement in the longitudinal direction of the push rod.

The input shaft is at least indirectly connected to a steering handle, preferably a steering wheel. The steering device converts the steering movement of the steering handle into a steering movement of the vehicle. To this end, the rotational movement of the input shaft is converted into the translatory movement of the push rod by the actuator, wherein the push rod interacts with the respective wheel suspensions and thus also with the respective wheels of the steerable vehicle axle via the respective coupling rods, the respective deflection levers pivotally connected thereto, the respective tie rods pivotally connected thereto and the respective steering levers pivotally connected thereto.

The input shaft may be mechanically, electrically, pneumatically or hydraulically coupled to the push rod via the actuator. Owing to the simple manufacture, the mechanical coupling can preferably be implemented as a toothed rack and pinion combination. For this purpose, a first gear is located for instance on the input shaft, which gear meshes with a toothed rack arranged on the push rod. Rotation of the input shaft causes rotation of the gear, which is engaged with the toothed rack, thereby axially displacing the toothed rack in conjunction with the push rod. Preferably, the push rod is designed as a toothed rack and thus integrated into the push rod in one piece.

The electrical coupling of the input shaft to the push rod may be such that a sensor is arranged on the input shaft, which detects rotation of the input shaft. In contrast, an actuator is arranged on the push rod, which can move the push rod axially, wherein the actuator is actuated upon detection of rotation of the input shaft by the sensor to move the push rod accordingly.

In a hydraulic or pneumatic coupling, for example, one or more valves are arranged as sensors on the input shaft. Upon rotation of the input shaft, a pressure medium is routed into two power cylinders arranged on the push rod, whereby one piston rod each of the working cylinder extends or retracts. The piston rod is in turn connected to the push rod, axially displacing the latter when the piston rods are extended or retracted.

Preferably, the actuator and the two deflection levers are arranged on different horizontal planes. A horizontal plane is a plane that is parallel to the street level. In other words, the vertical axis of the vehicle is perpendicular to the horizontal plane. In contrast, the longitudinal axis of the vehicle is parallel to the horizontal plane. As a consequence, the actuator is arranged on a first horizontal plane and the respective deflection levers are arranged on a second horizontal plane, wherein the two horizontal planes are axially spaced from each other. In this way, construction space is freed, in particular in the immediate vicinity of the actuator, which can be used by other vehicle components, in particular a motor or an oil pan.

### BRIEF DESCRIPTION OF THE DRAWINGS

Exemplary embodiments of the invention will be described in greater detail based on the drawings below. In the figures

FIG. 1 shows a greatly simplified schematic plan view of a steering device according to the invention, and

FIG. 2 shows a schematic perspective view of the steering device according to the invention according to FIG. 1.

### DETAILED DESCRIPTION OF THE EMBODIMENTS

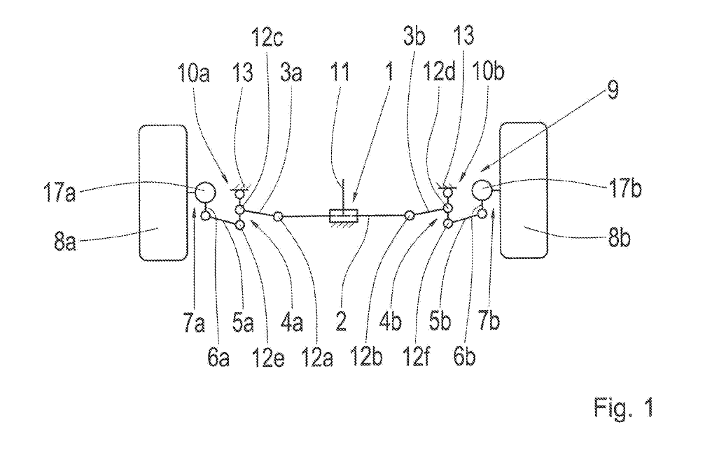

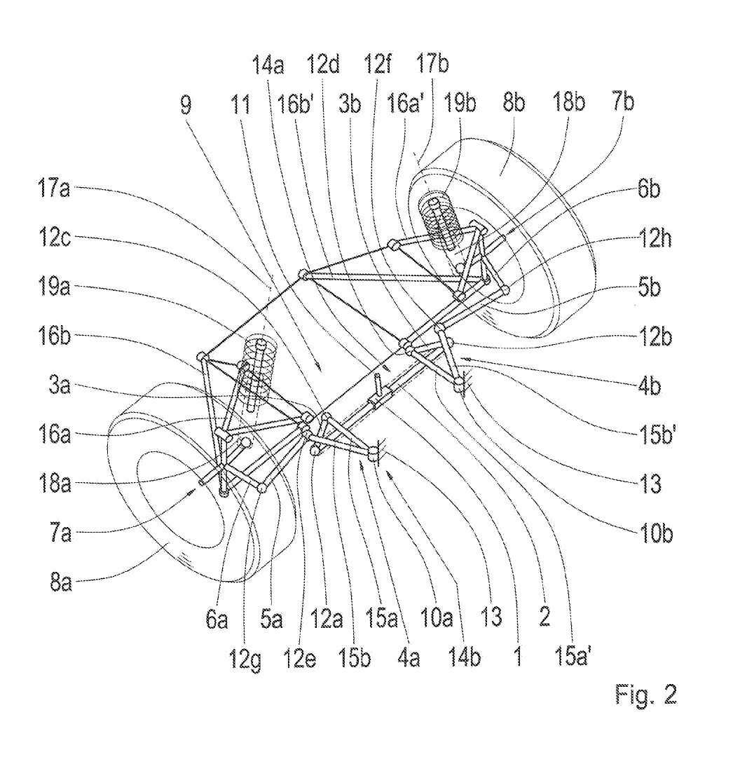

According to FIGS. 1 and 2, a steering device according to the invention for a vehicle—not shown here—has an actuator 1, which is operatively connected to an input shaft 11 and a push rod 2. The actuator 1 is provided to convert rotational movement of the input shaft 11 into translatory movement of the push rod 2. Consequently, upon rotation of the input shaft 11 in a first direction of rotation, axial movement of the push rod 2 in the direction of a first wheel 8a occurs. Accordingly, upon rotation of the input shaft 11 in a second direction of rotation, axial movement of the push rod 2 in the direction of a second wheel 8b occurs. The two wheels 8a, 8b are part of a vehicle axle 9 and are rotated in accordance with rotational movement of the input shaft 11 via the steering device at least partially about the respective steering axes 17a, 17b.

The actuator 1 is provided to exert an axial force on the push rod 2. In this case, the push rod 2 is formed in one part and has two distal ends. At the respective distal ends, the push rod 2 is pivotally connected to the respective coupling rods 3a, 3b. The respective ball joints 12a, 12b are arranged between the push rod 2 and the respective coupling rods 3a, 3b. Further, the respective coupling rods 3a, 3b are pivotally connected to the respective levers 4a, 4b, and the respective ball joints 12c, 12d being provided there as well.

The respective deflection levers 4a, 4b have a first and a second leg 15a, 15a′, 15b, 15b′, wherein the respective first legs 15a, 15a′ are rotationally engaged with the respective second legs 15b, 15b′. Consequently, any angle enclosed between the two respective legs 15a, 15b and 15a′, 15b′ is always constant. The respective deflection levers 4a, 4b are arranged at least partially attached at the frame and thus at least partially movable, in particular pivotally attached to a frame 13 of the vehicle. Furthermore, the respective deflection levers 4a, 4b have hinge joints 10a, 10b, wherein the respective hinge joints 10a, 10b enable rotational movement of the respective deflection levers 4a, 4b at the frame 13. Further, the respective deflection levers 4a, 4b are pivotally connected to respective tie rods 5a, 5b, wherein respective ball joints 12e, 12f are also provided there. The respective deflection levers 4a, 4b are provided to alter a gear ratio between the push rod 2 and the respective tie rods 5a, 5b, to lower the axial force at the actuator 1. In particular, the respective deflection levers 4a, 4b generate a level transmission ratio, which is largely constant along an entire steering angle, between the push rod 2 and the respective tie rods 5a, 5b. The steering kinematics of the steering device is considerably improved.

The respective tie rods 5a, 5b are pivotally connected to respective steering levers 6a, 6b, wherein respective ball joints 12g, 12h are arranged between the respective tie rods 5a, 5b and the respective steering levers 6a, 6b. The respective steering levers 6a, 6b interact with the respective hub carriers 7a, 7b to steer the respective wheels 8a, 8b of the vehicle axle 9 in accordance with the axial movement of the push rod 2.

FIG. 2 shows a perspective view of the steering device shown in FIG. 1, wherein in FIG. 2 shows in particular that the actuator 1 and the two deflection levers 4a, 4b are arranged on different horizontal planes 14a, 14b. In this case, the actuator 1 is arranged on a first horizontal plane 14a and the two deflection levers 4a, 4b are arranged on a second horizontal plane 14b. The two horizontal planes 14a, 14b are spaced apart, wherein the distance between the two horizontal planes 14a, 14b is bridged by means of the respective coupling rods 3a, 3b. The respective wheels 8a, 8b are attached to the vehicle via an independent suspension and connected to the vehicle via the respective upper arm planes 16a, 16a′ and the respective lower arm planes 16b, 16b′. To form respective shock absorbing struts, respective shock absorbers 18a, 18b and respective springs 19a, 19b are provided in addition to the respective hub carriers 7a, 7b, wherein the respective hub carriers 7a, 7b, the respective shock absorbers 18a, 18b and the respective springs 19a, 19b are operatively connected to on another.

The invention is not limited to the exemplary embodiment above. Further options for development can be found in the description and the claims. In particular, individual articulated connections can also be implemented using rubber bearings. Furthermore, other articulated connection options having at least one degree of freedom are conceivable.

### REFERENCE NUMERALS

1 actuator

2 push rod

3a, 3bcoupling rods

4a, 4b deflection levers

5a, 5b tie rods

6a, 6b steering levers

7a, 7b hub carriers

8a, 8b wheels

9 vehicle axle

10a, 10b hinge joints

11 input shaft

12a-12h ball joints

13 frame

14a, 14b horizontal plane

15a, 15a′ first leg

15b, 15b′ second leg

16a, 16a′ upper arm planes

16b, 16b′ lower arm planes

17a, 17b steering axes

18a, 18b shock absorbers

19a, 19b springs

1-7. (canceled)

8. A steering device for a vehicle, comprising an actuator (1), which is provided to exert an axial force on a push rod (2), the push rod (2) is pivotally connected to respective coupling rods (3a, 3b) on both sides, the respective coupling rods (3a, 3b) are pivotally connected to respective deflection levers (4a, 4b), the respective deflection levers (4a, 4b) are pivotally connected to respective tie rods (5a, 5b), and the respective tie rods (5a, 5b) are pivotally connected to respective steering levers (6a, 6b), the respective steering levers (6a, 6b) being operatively connected to respective hub carriers (7a, 7b) to steer respective wheels (8a, 8b) of a vehicle axle (9) in accordance with axial movement of the push rod (2), and the respective deflection levers (4a, 4b) are provided to alter a transmission ratio between the push rod (2) and the respective tie rods (5a, 5b) to lower the axial force at the actuator (1).

9. The steering device according to claim 8, wherein the respective deflection levers (4a, 4b) have a first and a second leg (15a, 15a′, 15b, 15′, the first and the second legs (15a, 15a′, 15b, 15b′) are rotatably engaged with each other.

10. The steering device according to claim 8, wherein the respective deflection levers (4a, 4b) are at least partially fixed, the respective deflection levers (4a, 4b) have hinge joints (10a, 10b) for implementing a swivel movement.

11. The steering device according to claim 8, wherein the actuator (1) is operatively connected to an input shaft (11), the actuator (1) is provided to transform a rotational movement of the input shaft (11) into a translatory movement of the push rod (2).

12. The steering device according to claim 8, wherein the push rod (2) is designed as a toothed rack.

13. The steering device according to claim 8, wherein the actuator (2) and the two deflection levers (4a, 4b) are arranged on different horizontal planes (14a, 14b).

14. Use of a steering device according to claim 8, in a car or commercial vehicle.

15. A steering device for a vehicle, the steering device comprising
an actuator which is provided to exert an axial force on a push rod, the push rod having axially opposite first and second ends,
the first end of the push rod is pivotally connected to first coupling rod and the second end of the push rod is pivotally connected to a second coupling rod,
the first coupling rod is pivotally connected to a first deflection lever and the second coupling rod is pivotally connected to a second deflection lever,
the first deflection lever is pivotally connected to a first tie rod and the second deflection lever is pivotally connected to a second tie rod,
the first tie rod is pivotally connected to a first steering lever and the second tie rod is pivotally connected to a second steering lever,
the first and the second steering levers are operatively connected to first and second hub carriers, respectively, to steer first and second wheels, respectively, of a vehicle axle in accordance with axial movement of the push rod, and
the first and the second deflection levers alter a transmission ratio between the push rod and the first and the second tie rods, respectively, to lower the axial force at the actuator.
